(19) United States
(12) Patent Application Publication
(10) Pub. No.: US 2018/0180975 A1
(43) Pub. Date: Jun. 28, 2018

(54) WAVELENGTH CONVERSION MEMBER AND LIGHT-EMITTING DEVICE

(71) Applicant: NIPPON ELECTRIC GLASS CO., LTD., Otsu-shi, Shiga (JP)

(72) Inventors: Tadahito FURUYAMA, Otsu-shi (JP); Shunsuke FUJITA, Otsu-shi (JP)

(21) Appl. No.: 15/742,539

(22) PCT Filed: Sep. 2, 2016
(86) PCT No.: PCT/JP2016/075828

§ 371 Date: Jan. 8, 2018

(30) Foreign Application Priority Data
Sep. 15, 2015 (JP) 2015-181709
Jan. 15, 2016 (JP) 2016-005767

(51) Int. Cl. G03B 21/20; C09K 11/02; C09K 11/77; C03C 4/12; C03C 14/00; C04B 37/04; C03B 19/06

(52) U.S. Cl. CPC G03B 21/204; C09K 11/02; C09K 11/7706; C03C 4/12; C04B 2237/70; C04B 37/042; C03B 19/06; C03C 2214/04; C04B 2237/343; C03C 14/004

(57) ABSTRACT

Provided is a wavelength conversion member that can reduce strain under stress occurring at the interface between a substrate and a phosphor layer and is therefore less susceptible to breakage during use. The wavelength conversion member 1 comprises a substrate 10 and a phosphor layer 20 bonded on the substrate 10, the phosphor layer 20 including inorganic phosphor powder 22 dispersed in a glass matrix 21. In a temperature range of 30° C. to a setting point of the phosphor layer 20, a relation −10×10⁻⁷≤(α₁−α₂)≤10×10⁻⁷ (/° C.) is satisfied where α₁ represents a coefficient of thermal expansion of the substrate 10 and α₂ represents a coefficient of thermal expansion of the phosphor layer 20. The setting point is defined by Tf−(Tf−Tg)/3 (where Tg represents a glass transition point and Tf represents a deformation point).

### TECHNICAL FIELD

The present invention relates to wavelength conversion members suitable as phosphor wheels for projectors or the like and light-emitting devices using the same.

### BACKGROUND ART

To reduce projector size, there have recently been proposed light-emitting devices in which a light source, such as an LED (light emitting diode), and a wavelength conversion member including a phosphor layer are used. For example, a so-called reflective phosphor wheel is proposed in which light from a light source is converted in wavelength to fluorescence by a phosphor layer and the resultant fluorescence is reflected, by a reflective substrate provided adjacent to a wavelength conversion member, toward the side through which the light from the light source has entered the phosphor layer, thus extracting the reflected light to the outside (see, for example, Patent Literature 1). The reflective phosphor wheel has the advantage of having a high efficiency of fluorescence extraction to the outside and therefore easily giving a projector a high intensity.

The phosphor layer is accompanied by heat production due to light irradiation from the light source and therefore required to have thermal resistance. In this relation, there is proposed a wavelength conversion member having a phosphor layer which includes inorganic phosphor powder dispersed in a highly thermally resistant glass matrix. However, in this case, a difference in coefficient of thermal expansion between the phosphor layer and the reflective substrate may cause strain under stress at the interface between them. For example, if a metallic substrate is used as the reflective substrate, a large difference in coefficient of thermal expansion from the phosphor layer causes large strain under stress. As a result, when undergoing vibrations or the like during use, the phosphor layer may have problems, such as development of cracks or peeling off the reflective substrate.

In order to reduce the above problems, a method for reducing the difference in coefficient of thermal expansion between the reflective substrate and the phosphor layer is conceivable. For example, Prior Art Literature 2 discloses a wavelength conversion member (a phosphor wheel for a projector) in which a reflective substrate has a double structure composed of a ceramic substrate and a reflective metal layer and a phosphor layer is provided on the ceramic substrate side of the reflective substrate. The ceramic substrate has a low coefficient of thermal expansion as compared to a metallic material and, therefore, can reduce the difference in coefficient of thermal expansion from the phosphor layer.

### CITATION LIST

### Patent Literature

[PTL 1]
JP-A-2015-1709
[PTL 2]
WO2015/068562

### SUMMARY OF INVENTION

### Technical Problem

Even if the difference in coefficient of thermal expansion between the reflective substrate and the phosphor layer is reduced, there are cases where strain under stress occurring at the interface between them cannot sufficiently be reduced.

Therefore, a technical challenge for the present invention is to provide a wavelength conversion member that can reduce strain under stress occurring at the interface between a substrate and a phosphor layer and is therefore less susceptible to breakage during use.

### Solution to Problem

A wavelength conversion member according to the present invention is a wavelength conversion member comprising a substrate and a phosphor layer bonded on the substrate, the phosphor layer including inorganic phosphor powder dispersed in a glass matrix, wherein the wavelength conversion member satisfies, in a temperature range of 30° C. to a setting point of the phosphor layer, a relation −10×10⁻⁷≤(α₁−α₂)≤10×10⁻⁷ (/° C.) where α₁ represents a coefficient of thermal expansion of the substrate and α₂ represents a coefficient of thermal expansion of the phosphor layer. In this case, the setting point refers to a temperature represented by Tf−(Tf−Tg)/3 (where Tg represents a glass transition point and Tf represents a deformation point).

Previous studies of the inventors have shown that strain under stress occurring at the interface between the substrate and the phosphor layer in the wavelength conversion member is due to its production process. Specifically, this can be explained as follows.

A wavelength conversion member comprising a phosphor layer formed on a substrate is produced, for example, by applying a green sheet containing glass powder and inorganic phosphor powder onto a substrate and firing the green sheet. More specifically, when the green sheet is fired, a phosphor layer made of a sintered body of the glass powder and the inorganic phosphor powder is formed. The phosphor layer is set at its setting point to the substrate and then cooled to nearly normal temperature, thus obtaining a wavelength conversion member in which the phosphor layer is formed on the substrate. In doing so, if the difference in coefficient of thermal expansion between the substrate and the phosphor layer is large in a temperature range of 30° C. to the setting point of the phosphor layer, residual stress is likely to occur at the interface between the phosphor layer and the substrate in the process of decreasing temperature after the phosphor layer sets on the substrate. To cope with this, the difference in coefficient of thermal expansion between the substrate and the phosphor layer is specified as described above in the temperature ranges of 30° C. to the setting point of the phosphor layer. Thus, the occurrence of the above problems can be reduced.

In the wavelength conversion member according to the present invention, the substrate is preferably made of oxide ceramic or glass.

In the wavelength conversion member according to the present invention, the oxide ceramic is preferably polycrystalline alumina or single-crystal sapphire.

In the wavelength conversion member according to the present invention, the phosphor layer is preferably fusion bonded to the substrate. With the above structure, the phosphor layer and the substrate can be bonded together without the use of a resin adhesive or the like having low thermal resistance, so that a wavelength conversion member having excellent thermal resistance can be obtained. Specifically, whereas resin adhesives are degraded and blackened by heat due to irradiation with excitation light and are therefore likely to decrease the luminescence intensity with time, the above structure is less likely to cause this problem. Furthermore, the resin adhesives have low thermal conductivity. Therefore, when the phosphor layer and the substrate are bonded by a resin adhesive, heat generated in the phosphor layer is less likely to be released to the substrate side. In contrast, when the phosphor layer is fusion bonded to the substrate, heat generated in the phosphor layer is likely to be efficiently released to the substrate side.

In the wavelength conversion member according to the present invention, the phosphor layer preferably has a thickness of 30 to 300 μm.

In the wavelength conversion member according to the present invention, the inorganic phosphor powder is preferably one or more selected from the group consisting of nitride phosphor, oxynitride phosphor, oxide phosphor, sulfide phosphor, oxysulfide phosphor, halide phosphor, and aluminate phosphor.

In the wavelength conversion member according to the present invention, a content of the inorganic phosphor powder in the phosphor layer is preferably 30 to 80% by volume.

The wavelength conversion member according to the present invention preferably has a wheel shape. With this structure, heat release due to rotation is facilitated, so that breakage or temperature quenching due to a temperature increase of the phosphor layer can be reduced. Therefore, the wavelength conversion member according to the present invention is suitable for a light source for a high-intensity projector.

A light-emitting device according to the present invention includes: the above-described wavelength conversion member; and a light source capable of irradiating the phosphor layer of the wavelength conversion member with excitation light.

The light-emitting device according to the present invention is suitable as a light source for a projector.

A method for producing a wavelength conversion member according to the present invention includes the steps of: preparing a green sheet containing glass powder and inorganic phosphor powder; and applying the green sheet to a substrate and firing the green sheet to form a phosphor layer. In this method, in a temperature range of 30° C. to a setting point of the phosphor layer, a relation −10×10⁻⁷≤(α₁−α₂)≤10×10⁻⁷ (/° C.) is satisfied where α₁ represents a coefficient of thermal expansion of the substrate and α₂ represents a coefficient of thermal expansion of the phosphor layer. In this case, like the above, the setting point refers to a temperature represented by Tf−(Tf−Tg)/3 (where Tg represents a glass transition point and Tf represents a deformation point).

### Advantageous Effects of Invention

The present invention enables provision of a wavelength conversion member that can reduce strain under stress occurring at the interface between a substrate and a phosphor layer and is therefore less susceptible to breakage during use.

### BRIEF DESCRIPTION OF DRAWINGS

FIG. 1 is a schematic cross-sectional view of a wavelength conversion member according to one embodiment of the present invention.

FIG. 2 is a schematic side view of a light-emitting device in which the wavelength conversion member according to the one embodiment of the present invention is used.

### DESCRIPTION OF EMBODIMENTS

Hereinafter, a description will be given of a preferred embodiment of the present invention. However, the following embodiment is merely illustrative and the present invention is not at all limited to the following embodiment.

(Wavelength Conversion Member 1)

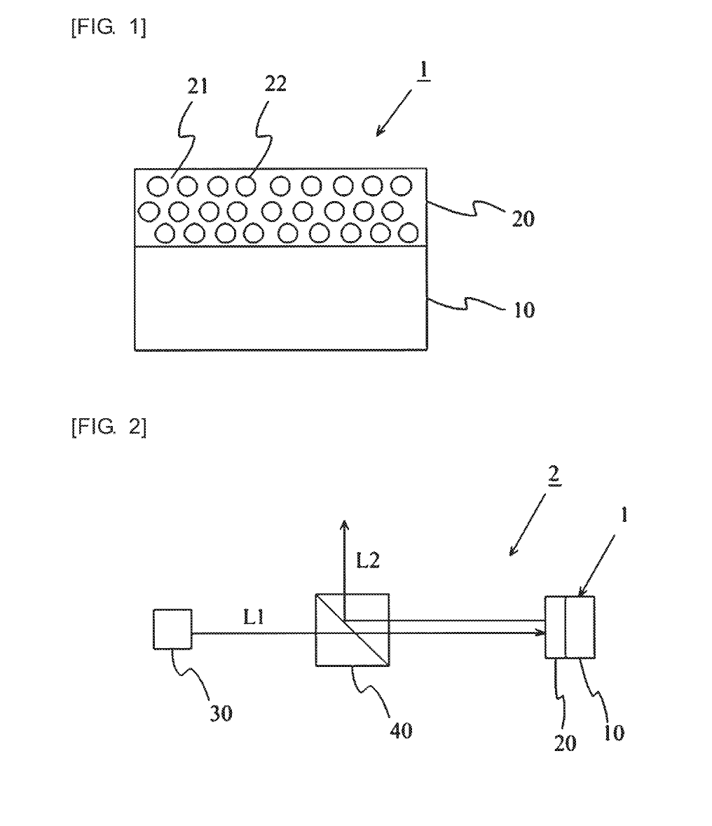

FIG. 1 is a schematic cross-sectional view of a wavelength conversion member showing one embodiment of the present invention. As shown in FIG. 1, a wavelength conversion member 1 includes a substrate 10 and a phosphor layer 20 bonded to a surface of the substrate 10. The phosphor layer 20 comprises inorganic phosphor powder 22 dispersed in a glass matrix 21.

The phosphor layer 20 is preferably fusion bonded to the substrate 10. An example of an inorganic bonding layer that can be cited is a glass layer. A specific example that can be cited is a glass layer having the same composition as the glass matrix 21.

The shape and dimension of the wavelength conversion member 1 can be appropriately selected according to the shape, dimension, and so on of a device for which the wavelength conversion member 1 is used. Examples of the shape of the wavelength conversion member 1 include a rectangular plate shape, a disc shape, and a wheel shape. Particularly when used as a light source for a projector, the wavelength conversion member preferably has a wheel shape. The phosphor layer 20 may be formed on the whole of a surface (at least one principal surface) of the substrate 10 or may be formed only on a portion of the surface of the substrate 10.

(Substrate 10)

Examples of the substrate 10 include a substrate made of oxide ceramic or glass. Examples of the oxide ceramic include polycrystalline alumina and single-crystal sapphire. The polycrystalline alumina may be formed of a porous body. The polycrystalline alumina is used as a reflective substrate. On the other hand, the single-crystal sapphire is light-transmissive and, therefore, can be used as a transmissive wavelength conversion member.

(Phosphor Layer 20)

The phosphor layer 20 contains a glass matrix 21 and inorganic phosphor powder 22. For example, the phosphor layer 20 comprises the inorganic phosphor powder 22 dispersed in the glass matrix 21 made of a sintered body of glass powder. In this manner, there can be easily obtained a phosphor layer 20 with inorganic phosphor powder 22 uniformly dispersed in a glass matrix 21.

The composition of the glass matrix 21 is preferably, for example, a composition in which one or both of SiO₂ and B₂O₃ are contained in an amount of 60 to 90% by mass. Specific examples include SiO₂—B₂O₃—RO-based glasses (where R represents Mg, Ca, Sr or Ba), SiO₂—B₂O₃—R′₂O-based glasses (where R′ represents Li, Na or Ka), and SiO₂—B₂O₃—RO—R′₂O-based glasses.

In this embodiment, in a temperature range of 30° C. to a setting point of the phosphor layer 20, a relation −10×10⁻⁷≤(α₁−α₂)≤10×10⁻⁷ (/° C.) is satisfied where α₁ represents a coefficient of thermal expansion of the substrate 10 and α₂ represents a coefficient of thermal expansion of the phosphor layer 20. If (α₁−α₂) is too small, strain under stress occurring at the interface between the substrate 10 and the phosphor layer 20 (tensile stress which the substrate 10 applies to the phosphor 20) becomes large for the previously described reason, so that the phosphor layer 20 may be broken during use. On the other hand, if (α₁−α₂) is too large, strain under stress occurring at the interface between the substrate 10 and the phosphor layer 20 (compressive stress which the substrate 10 applies to the phosphor 20) becomes large, so that the phosphor layer 20 is likely to be peeled off the substrate 10. Therefore, (α₁−α₂) is preferably not less than −8×10⁻⁷, particularly not less than −6×10⁻⁷ (/° C.), and preferably not more than 8×10⁻⁷, particularly not more than 6×10⁻⁷ (/° C.).

No particular limitation is placed on the type of the inorganic phosphor powder 22 so long as it is commercially available. Examples include nitride phosphor powder, oxynitride phosphor powder, oxide phosphor powder (including garnet-based phosphor powder, such as YAG phosphor powder), sulfide phosphor powder, oxysulfide phosphor powder, halide phosphor powder (such as halophosphoric acid chloride powder), and aluminate phosphor powder. Among them, nitride phosphor powder, oxynitride phosphor powder, and oxide phosphor powder are preferred because they have high thermal resistance and are therefore relatively less susceptible to degradation during firing. Note that nitride phosphor powder and oxynitride phosphor powder have a feature that they convert near-ultraviolet to blue excitation light to a wide wavelength range of green to red light and additionally have a relatively high luminescence intensity. Therefore, nitride phosphor powder and oxynitride phosphor powder are effective as the inorganic phosphor powder 22 particularly for use in a wavelength conversion member for a white LED device.

Examples of the inorganic phosphor powder 22 include those having an excitation band in a wavelength range of 300 to 500 nm and a luminescence peak at a wavelength of 380 to 780 nm and particular examples include those producing blue luminescence (with wavelengths of 440 to 480 nm), those producing green luminescence (with wavelengths of 500 to 540 nm), those producing yellow luminescence (with wavelengths of 540 to 595 nm), and those producing red luminescence (with wavelengths of 600 to 700 nm).

Examples of the inorganic phosphor powder that produces blue luminescence upon irradiation with ultraviolet to near-ultraviolet excitation light having a wavelength of 300 to 440 nm include (Sr, Ba)MgAl₁₀O₁₇:Eu²⁺ and (Sr, Ba)₃MgSi₂O₈:Eu²⁺.

Examples of the inorganic phosphor powder that produces green fluorescence upon irradiation with ultraviolet to near-ultraviolet excitation light having a wavelength of 300 to 440 nm include: SrAl₂O₄:Eu²⁺; SrBaSiO₄:Eu²⁺; Y₃(Al, Gd)₅O₁₂:Ce²⁺; SrSiOₙ:Eu²⁺; BaMgAl₁₀O₁₇: Eu²⁺, Mn²⁺; Ba₂MgSi₂O₇: Eu²⁺; Ba₂SiO₄: Eu²⁺; Ba₂Li₂Si₂O₇:Eu²⁺; and BaAl₂O₄:Eu²⁺.

Examples of the inorganic phosphor powder that produces green fluorescence upon irradiation with blue excitation light having a wavelength of 440 to 480 nm include SrAl₂O₄:Eu²⁺, SrBaSiO₄:Eu²⁺, Y₃(Al, Gd)₅O₁₂:Ce³⁺, SrSiOₙ:Eu²⁺, and β-SiAlON:Eu²⁺.

An example of the inorganic phosphor powder that produces yellow fluorescence upon irradiation with ultraviolet to near-ultraviolet excitation light having a wavelength of 300 to 440 nm is La₃Si₆N₁₁:Ce³⁺.

Examples of the inorganic phosphor powder that produces yellow fluorescence upon irradiation with blue excitation light having a wavelength of 440 to 480 nm include Y₃(Al, Gd)₅O₁₂:Ce³⁺ and Sr₂SiO₄:Eu²⁺.

Examples of the inorganic phosphor powder that produces red fluorescence upon irradiation with ultraviolet to near-ultraviolet excitation light having a wavelength of 300 to 440 nm include: CaGa₂S₄:Mn²⁺; MgSr₃Si₂O₈:Eu²⁺, Mn²⁺; and Ca₂MgSi₂O₇:Eu²⁺, Mn²⁺.

Examples of the inorganic phosphor powder that produces red fluorescence upon irradiation with blue excitation light having a wavelength of 440 to 480 nm include CaAlSiN₃:Eu²⁺, CaSiN₃:Eu²⁺, (Ca, Sr)₂Si₅N₈:Eu²⁺, and α-SiAlON:Eu²⁺.

A plurality of types of inorganic phosphor powders may be used according to the wavelength range of excitation light or luminescence. For example, in providing white light by irradiation with excitation light in the ultraviolet range, respective inorganic phosphor powders that produce blue, green, yellow, and red fluorescences may be used in mixture.

If the content of the inorganic phosphor powder 22 in the phosphor layer 20 is too large, the sinterability decreases and, thus, the mechanical strength of the phosphor layer 20 is likely to decrease. On the other hand, if the content of the inorganic phosphor powder 22 is too small, a desired luminescence intensity is less likely to be achieved. From these viewpoints, the content of the inorganic phosphor powder 22 in the phosphor layer 20 is, in % by volume, preferably 20 to 90%, more preferably 30 to 80%, and particularly preferably 40 to 75%.

If the average particle size of the inorganic phosphor powder 22 is too large, the luminescent color may be uneven. Therefore, the average particle size of the inorganic phosphor powder 22 is preferably 50 μm or less and particularly preferably 25 μm or less. However, if the average particle size of the inorganic phosphor powder 22 is too small, the luminescence intensity may decrease. Therefore, the average particle size of the inorganic phosphor powder 22 is preferably 1 μm or more and particularly preferably 5 μm or more.

The thickness of the phosphor layer 20 is preferably 30 to 300 μm and particularly preferably 50 to 200 μm. If the thickness of the phosphor layer 20 is too small, a desired luminescence intensity is less likely to be achieved. On the other hand, if the thickness of the phosphor layer 20 is too large, the efficiency of light extraction from the phosphor layer 20 becomes poor and, thus, the luminescence intensity tends to decrease. Note that as the thickness of the phosphor layer 20 increases, the stress at the interface between the phosphor layer 20 and the substrate 10 is likely to increase and, therefore, the effects of the present invention are more likely to be enjoyed.

(Method for Producing Wavelength Conversion Member 1)

Next, a description will be given of an example of a method for producing a wavelength conversion member 1.

First, a green sheet is prepared using a mixed powder containing glass powder for forming a glass matrix 21 and inorganic phosphor powder 22. Specifically, an organic solvent, a resin binder, and so on are added in appropriate amounts to the mixed powder, the mixture is kneaded to obtain a slurry, and the slurry is then formed into a sheet on a resin film made of, for example, PET (polyethylene terephthalate), thus preparing a green sheet.

The maximum particle size (Dmax) of the glass powder is preferably 200 μm or less (particularly preferably 150 μm or less and more particularly preferably 105 μm or less) and the average particle size (D50) thereof is preferably 0.1 μm or more (particularly preferably 1 μm or more and more particularly preferably 2 μm or more). If the maximum particle size of the glass powder is too large, excitation light becomes less likely to scatter in the phosphor layer 20 and, thus, the luminous efficiency is likely to decrease. Furthermore, if the average particle size is too small, excitation light excessively scatters in the phosphor layer 20, so that the luminous efficiency is contrariwise likely to decrease.

Note that in the present invention the maximum particle size and the average particle size refer to values measured by laser diffractometry.

Next, the green sheet and a substrate 10 are laid on top of each other, and pressed if necessary, thus preparing a laminate. The laminate is fired to obtain a wavelength conversion member 1. As for the substrate 10 and the glass powder, their materials are selected so that their coefficients of thermal expansion satisfy the previously described relation. The firing temperature is preferably the softening point of the glass powder or above in order to obtain a dense sintered body. On the other hand, if the firing temperature is too high, the inorganic phosphor powder may elute into the glass powder to decrease the luminescence intensity. Therefore, the firing temperature is preferably not more than the glass powder softening point plus 150° C. and particularly preferably not more than the glass powder softening point plus 100° C.

(Light-Emitting Device 2)

FIG. 2 is a schematic side view of a light-emitting device 2 in which the wavelength conversion member 1 is used. The light-emitting device 2 includes the wavelength conversion member 1 and a light source 30. The light source 30 irradiates the wavelength conversion member 1 with excitation light L1. When the excitation light L1 enters the phosphor layer 20 of the wavelength conversion member 1, it is converted in wavelength to fluorescence L2. The fluorescence L2 is reflected by the substrate 10, which is a reflective substrate, and emitted toward the light source 30. The fluorescence L2 is isolated and extracted to the outside by a beam splitter 40 interposed between the light source 30 and the wavelength conversion member 1.

### EXAMPLES

The present invention will be described below in further detail with reference to specific examples. However, the present invention is not at all limited to the following examples and modifications and variations may be appropriately made therein without changing the gist of the invention.

Table 1 shows Examples 1 to 3 and Comparative Examples 1 and 2.

TABLE 1

| | | | Ex. 1 | Ex. 2 | Ex. 3 | Comp. Ex. 1 | Comp. Ex. 2 |
|---|---|---|---|---|---|---|---|
| Substrate | Material | | alumina | | | | |
| | CTE (30° C. to Setting Point) α₁ | | 73.8 | 75.7 | 75.9 | 72.4 | 74.8 |
| | (×10⁻⁷/° C.) | | | | | | |
| Glass | Glass Composition | SiO₂ | 71 | 46 | 79 | 55.5 | 50 |
| Matrix | (% by mass) | Al₂O₃ | 6 | 20 | 0.5 | 9.5 | 6 |
| | | B₂O₃ | 13 | 24 | 18.5 | 19 | 5 |
| | | Li₂O | | | | 4 | |
| | | Na₂O | 7 | | | 8 | |
| | | K₂O | 1 | | 1.5 | 4 | |
| | | MgO | | | 0.5 | | |
| | | CaO | 1 | 8 | | | 12 |
| | | BaO | 1 | | | | 25 |
| | | ZnO | | | | | 2 |
| | | ZrO₂ | | 2 | | | |

| | | | | | | |
|---|---|---|---|---|---|---|
| | Softening Point (° C.) | 775 | 820 | 825 | 600 | 850 |
| Phosphor | Glass Transition Point Tg (° C.) | 579 | 700 | 618 | 497 | 683 |
| Layer | Deformation Point Tf (° C.) | 670 | 834 | 873 | 566 | 748 |
| | Setting Point (° C.) | 640 | 789 | 788 | 543 | 726 |
| | CTE (30° C. to Setting Point) α₂ | 78.8 | 73.0 | 71.2 | 93.4 | 86.5 |
| | (×10⁻⁷/° C.) | | | | | |

| | | | | | |
|---|---|---|---|---|---|
| Firing Temperature (° C.) | 800 | 900 | 900 | 660 | 900 |
| α₁ − α₂ (×10⁻⁷/° C.) | 5.0 | −2.7 | −4.7 | 21.0 | 11.7 |
| Amount of Warpage (mm) | 5 | −8 | −11 | 33 | 20 |

(1) Production of Wavelength Conversion Member

Raw materials were compounded to give each of the compositions described in Table 1 and each resultant mixture was subjected to a melt-quenching process to form glass into a film. The obtained glass film was wet ground using a ball mill to obtain glass powder having an average particle size of 2 μm.

The obtained glass powder and YAG phosphor powder (yttrium aluminum garnet: Y₃Al₅O₁₂, average particle size: 15 μm) were mixed using a vibrational mixer to give a glass powder to phosphor powder volume ratio of 30:70. A binder, a plasticizer, a solvent, and so on were added in appropriate amounts to 50 g of the obtained mixed powder and the mixture was kneaded for 24 hours, thus obtaining a slurry. The slurry was applied onto a PET film using the doctor blade method (with a blade gap of 200 μm) and dried, thus preparing a green sheet. The thickness of the obtained green sheet was 120 μm.

Applied to a surface of a polycrystalline alumina substrate (HA-96-2 manufactured by MARUWA Co., Ltd., 180 mm×15 mm, thickness: 0.25 mm) was a piece of the above green sheet cut to the same size as that of the substrate. A pressure of 10 kPa was put on the substrate and the piece of green sheet at 100° C. for three minutes using a thermocompression bonder, thus producing a laminate. The laminate was subjected to a degreasing treatment at 600° C. for an hour in the atmosphere and then fired at the firing temperature described in Table 1 for 30 minutes, thus producing a wavelength conversion member. The thickness of the phosphor layer in the obtained wavelength conversion member was 100 μm.

The setting point of the phosphor layer and the coefficient of thermal expansion in a temperature range of 30° C. to the setting point were measured in the following manners. The mixed powder of glass powder and YAG phosphor powder obtained above was pressed at 50 MPa using a die, thus producing a pressed powder. The pressed powder was fired in an electric furnace at the firing temperature described in Table 1 for 60 minutes, thus obtaining a dense sintered body. The obtained sintered body was processed into a predetermined shape, the processed sintered body was determined in terms of glass transition point Tg and deformation point Tf from its thermal expansion curve obtained using a TMA (thermo-mechanical analyzer) (Thermo Plus TMA8310 manufactured by Rigaku Corporation), and its setting point was calculated from the formula (setting point)=Tf−(Tf−Tg)/3. The thermal expansion curve changes to a straight line having a steep gradient in the process of temperature increase. In this case, the bending point of the thermal expansion curve was defined as the glass transition point Tg. When further increased in temperature, the sintered body apparently stops elongation owing to softening and is found to contract. In this case, the inflection point was defined as the deformation point Tf. Furthermore, the coefficient of thermal expansion in a temperature range of 30° C. to the setting point of the phosphor layer was calculated from the thermal expansion curve. Also for the polycrystalline alumina substrate, its coefficient of thermal expansion in a temperature range of 30° C. to the setting point of the phosphor layer was calculated from its thermal expansion curve obtained using a TMA.

(2) Evaluation of Properties

Each of the wavelength conversion members produced in the above manner was checked in terms of residual stress at the interface between the substrate and the phosphor layer. Note that both the substrate and the phosphor layer were opaque bodies and their optical strain could not be observed under a polarizing microscope or the like. Therefore, the amount of warpage of the wavelength conversion member was measured and defined as an index of the residual stress. Specifically, when a longitudinal end of the wavelength conversion member was pressed against a surface plate, the distance between an opposite end of the wavelength conversion member and the surface plate was measured and evaluated as the amount of warpage. In the table, the amount of warpage when the phosphor layer side of the wavelength conversion member warped in a concave manner is described as a positive value, and the amount of warpage when the substrate side thereof warped in a concave manner is described as a negative value.

As is obvious from Table 1, it can be seen that the wavelength conversion members in Examples 1 to 3 have small absolute values of amounts of warpage as compared to the wavelength conversion members in Comparative Examples 1 and 2, and, therefore, has small residual stress at the interface between the substrate and the phosphor layer.

### REFERENCE SIGNS LIST

1 wavelength conversion member
2 light-emitting device
10 substrate
20 phosphor layer
21 glass matrix
22 inorganic phosphor powder
30 light source
40 beam splitter

1: A wavelength conversion member comprising a substrate and a phosphor layer bonded on the substrate, the phosphor layer including inorganic phosphor powder dispersed in a glass matrix,
wherein the wavelength conversion member satisfies, in a temperature range of 30° C. to a setting point of the phosphor layer, a relation −10×10⁻⁷≤(α₁−α₂)≤10×10⁻⁷ (/° C.) where α₁ represents a coefficient of thermal expansion of the substrate and α₂ represents a coefficient of thermal expansion of the phosphor layer, and the setting point is defined by Tf−(Tf−Tg)/3 (where Tg represents a glass transition point and Tf represents a deformation point).

2: The wavelength conversion member according to claim 1, wherein the substrate is made of oxide ceramic or glass.

3: The wavelength conversion member according to claim 2, wherein the oxide ceramic is polycrystalline alumina or single-crystal sapphire.

4: The wavelength conversion member according to claim 1, wherein the phosphor layer is fusion bonded to the substrate.

5: The wavelength conversion member according to claim 1, wherein the phosphor layer has a thickness of 30 to 300 μm.

6: The wavelength conversion member according to claim 1, wherein the inorganic phosphor powder is made of one or more selected from the group consisting of nitride phosphor powder, oxynitride phosphor powder, oxide phosphor powder, sulfide phosphor powder, oxysulfide phosphor powder, halide phosphor powder, and aluminate phosphor powder.

7: The wavelength conversion member according to claim 1, wherein a content of the inorganic phosphor powder in the phosphor layer is 30 to 80% by volume.

8: The wavelength conversion member according to claim 1, having a wheel shape.

9: A light-emitting device comprising: the wavelength conversion member according to claim 1; and a light source capable of irradiating the phosphor layer of the wavelength conversion member with excitation light.

10: The light-emitting device according to claim 9, being used as a light source for a projector.

11: A method for producing a wavelength conversion member, the method comprising the steps of:
preparing a green sheet containing glass powder and inorganic phosphor powder; and
applying the green sheet to a substrate and firing the green sheet to form a phosphor layer,
wherein the wavelength conversion member satisfies, in a temperature range of 30° C. to a setting point of the phosphor layer, a relation −10×10⁻⁷≤(α₁−α₂)≤10×10⁻⁷ (/° C.) where α₁ represents a coefficient of thermal expansion of the substrate and α₂ represents a coefficient of thermal expansion of the phosphor layer, and the setting point is defined by Tf−(Tf−Tg)/3 (where Tg represents a glass transition point and Tf represents a deformation point).
